(19) United States
(12) Patent Application Publication
(10) Pub. No.: US 2026/0113667 A1
(43) Pub. Date: Apr. 23, 2026

(54) ROBUST WIRELESS LINK STRUCTURES

(71) Applicant: QUALCOMM Incorporated, San Diego, CA (US)

(72) Inventors: Onn HARAN, Even Yehuda (IL); Nir SHAPIRA, Raanana (IL); Eyal NAHUM, Yokneam Moshava (IL); Shay KOREN, Tel Aviv (IL); Alexander KATSOVSKY, Kfar-Saba (IL); Amos FREUND, Mishmarot (IL)

(21) Appl. No.: 19/365,606

(22) Filed: Oct. 22, 2025

Related U.S. Application Data
(60) Provisional application No. 63/710,046, filed on Oct. 22, 2024.

(51) Int. Cl. H04W 28/26; H04W 72/0446

(52) U.S. Cl. CPC H04W 28/26; H04W 72/0446

(57) ABSTRACT

This disclosure provides methods, components, devices, and systems for robust wireless link structures. For example, A first wireless communication device may transmit, via multiple first slots of a frame, first data to a second wireless communication device. The frame may include a fixed slot sequence having the first slots followed by a second slot. The first slots may have a first communication direction and the second slot has a second communication direction opposite the first communication direction. The first wireless communication device may receive, via the second slot of the frame, second data from the second wireless communication device. The second data may include feedback information for at least one slot of the first slots, and link control information may be absent from the second slot.

### CROSS REFERENCE

The present Application for Patent claims priority to U.S. Provisional Ser. No. 63/710,046 by KOREN et al., entitled “METHOD AND APPARATUS FOR ROBUST WIRELESS VIDEO LINK” and filed Oct. 22, 2024, which is assigned to the assignee hereof and incorporated by reference herein.

### TECHNICAL FIELD

This disclosure relates generally to wireless communication, and more specifically to systems, devices, methods, and techniques associated with robust wireless link structures.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), sixth generation (6G) systems, Institute of Electrical and Electronics Engineers (IEEE) 802.11 (Wi-Fi), IEEE 802.20, or the like. A wireless communication network may support communication by implementing system resources (such as frequency resources, time resources, spatial resources) in accordance with a wireless communication protocol.

FIG. 1 illustrates a network with a video camera, base device and interferer. The remote video camera 100 may include a video camera 102 that encodes video data into internal protocol (IP) packets, a video control 104 which may adjust an encoding rate based on target image quality, other camera parameters, or movement, a radio 106 for transmitting data (e.g., video IP packets) and receiving control messages (e.g., from the base device 110), and antennas 108 (e.g., ranging from 1 to 8). The remove video camera 100 may, for example, be included in a drone or other device with a wireless communications link. The base device 110 may include similar elements but may be optimized for a relatively lower transmission bandwidth. The base device 110 may, for example, be a drone controller. In some cases, a potential attacker 120 may be positioned near the remote video camera 100 or base device 110 with a dedicated radio 126. The attacker 120 may, for example, be a malicious attacker or, as another example, be any other type of interferer (e.g., source of interference).

In some cases, an existing wireless communication protocol (e.g., existing Wi-Fi or 3GPP protocols may be used for a video link (e.g., between the remote video camera 100 and the base device 110). However, existing wireless communication protocols may provide limited wireless performance due to relatively large header structures, inefficient bandwidth utilization, low resilience to interference conditions (e.g., attacks), or any combination thereof. These limitations may become particularly challenging in point-to-point communication scenarios (e.g., drone-to-controller links), where reliable wireless communication may be imperative, asymmetric data communication mechanisms may exist between communication directions (e.g., uplink and downlink), or both.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a first wireless communication device is described. The method may include transmitting, via a set of multiple first slots of a frame, first data to a second wireless communication device, where the frame includes a fixed slot sequence having the set of multiple first slots followed by a second slot, and where the set of multiple first slots have a first communication direction and the second slot has a second communication direction opposite the first communication direction and receiving, via the second slot of the frame, second data from the second wireless communication device, where the second data includes feedback information for at least one slot of the set of multiple first slots, and where link control information is absent from the second slot.

A first wireless communication device for wireless communications is described. The first wireless communication device may include a processing system that includes processor circuitry and memory circuitry that stores code. The processing system may be configured to cause the first wireless communication device to transmit, via a set of multiple first slots of a frame, first data to a second wireless communication device, where the frame includes a fixed slot sequence having the set of multiple first slots followed by a second slot, and where the set of multiple first slots have a first communication direction and the second slot has a second communication direction opposite the first communication direction and receive, via the second slot of the frame, second data from the second wireless communication device, where the second data includes feedback information for at least one slot of the set of multiple first slots, and where link control information is absent from the second slot.

Another first wireless communication device for wireless communications is described. The first wireless communication device may include means for transmitting, via a set of multiple first slots of a frame, first data to a second wireless communication device, where the frame includes a fixed slot sequence having the set of multiple first slots followed by a second slot, and where the set of multiple first slots have a first communication direction and the second slot has a second communication direction opposite the first communication direction and means for receiving, via the second slot of the frame, second data from the second wireless communication device, where the second data includes feedback information for at least one slot of the set of multiple first slots, and where link control information is absent from the second slot.

A non-transitory computer-readable medium storing code for wireless communications is described. The code may include instructions executable by one or more processors to transmit, via a set of multiple first slots of a frame, first data to a second wireless communication device, where the frame includes a fixed slot sequence having the set of multiple first slots followed by a second slot, and where the set of multiple first slots have a first communication direction and the second slot has a second communication direction opposite the first communication direction and receive, via the second slot of the frame, second data from the second wireless communication device, where the second data includes feedback information for at least one slot of the set of multiple first slots, and where link control information is absent from the second slot.

In some examples of the method, first wireless communication devices, and non-transitory computer-readable medium described herein, the fixed slot sequence may be configured in accordance with a ratio of a first quantity of first slots to a second quantity of second slots and the first quantity may be greater than the second quantity.

In some examples of the method, first wireless communication devices, and non-transitory computer-readable medium described herein, transmitting the first data may include operations, features, means, or instructions for transmitting a first portion of link control information corresponding to the frame and refraining from transmitting a second portion of link control information corresponding to the frame based on the frame being configured in accordance with the fixed slot sequence.

A method for wireless communications by a second wireless communication device is described. The method may include receiving, via a set of multiple first slots of a frame, first data from a first wireless communication device, where the frame includes a fixed slot sequence having the set of multiple first slots followed by a second slot, and where the set of multiple first slots have a first communication direction and the second slot has a second communication direction opposite the first communication direction and transmitting, via the second slot of the frame, second data to the first wireless communication device, where the second data includes feedback information for at least one slot of the set of multiple first slots, and where link control information is absent from the second slot.

A second wireless communication device for wireless communications is described. The second wireless communication device may include a processing system that includes processor circuitry and memory circuitry that stores code. The processing system may be configured to cause the second wireless communication device to receive, via a set of multiple first slots of a frame, first data from a first wireless communication device, where the frame includes a fixed slot sequence having the set of multiple first slots followed by a second slot, and where the set of multiple first slots have a first communication direction and the second slot has a second communication direction opposite the first communication direction and transmit, via the second slot of the frame, second data to the first wireless communication device, where the second data includes feedback information for at least one slot of the set of multiple first slots, and where link control information is absent from the second slot.

Another second wireless communication device for wireless communications is described. The second wireless communication device may include means for receiving, via a set of multiple first slots of a frame, first data from a first wireless communication device, where the frame includes a fixed slot sequence having the set of multiple first slots followed by a second slot, and where the set of multiple first slots have a first communication direction and the second slot has a second communication direction opposite the first communication direction and means for transmitting, via the second slot of the frame, second data to the first wireless communication device, where the second data includes feedback information for at least one slot of the set of multiple first slots, and where link control information is absent from the second slot.

A non-transitory computer-readable medium storing code for wireless communications is described. The code may include instructions executable by one or more processors to receive, via a set of multiple first slots of a frame, first data from a first wireless communication device, where the frame includes a fixed slot sequence having the set of multiple first slots followed by a second slot, and where the set of multiple first slots have a first communication direction and the second slot has a second communication direction opposite the first communication direction and transmit, via the second slot of the frame, second data to the first wireless communication device, where the second data includes feedback information for at least one slot of the set of multiple first slots, and where link control information is absent from the second slot.

In some examples of the method, second wireless communication devices, and non-transitory computer-readable medium described herein, the fixed slot sequence may be configured in accordance with a ratio of a first quantity of first slots to a second quantity of second slots and the first quantity may be greater than the second quantity.

In some examples of the method, second wireless communication devices, and non-transitory computer-readable medium described herein, receiving the first data may include operations, features, means, or instructions for receiving a first portion of link control information corresponding to the frame.

In some examples of the method, second wireless communication devices, and non-transitory computer-readable medium described herein, the second data includes second feedback information for at least a third slot of a second frame different than the frame.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates a network with a video camera, base device, and interferer.

FIG. 2 shows an example of a block diagram that supports robust wireless link structures.

FIG. 3 shows an example of a flowchart that supports robust wireless link structures.

FIG. 4 shows an example of a slot structure that supports robust wireless link structures.

FIGS. 5 and 6 show flowcharts illustrating methods that support robust wireless link structures.

FIG. 7 shows a block diagram of an example wireless communication device that supports robust wireless link structures.

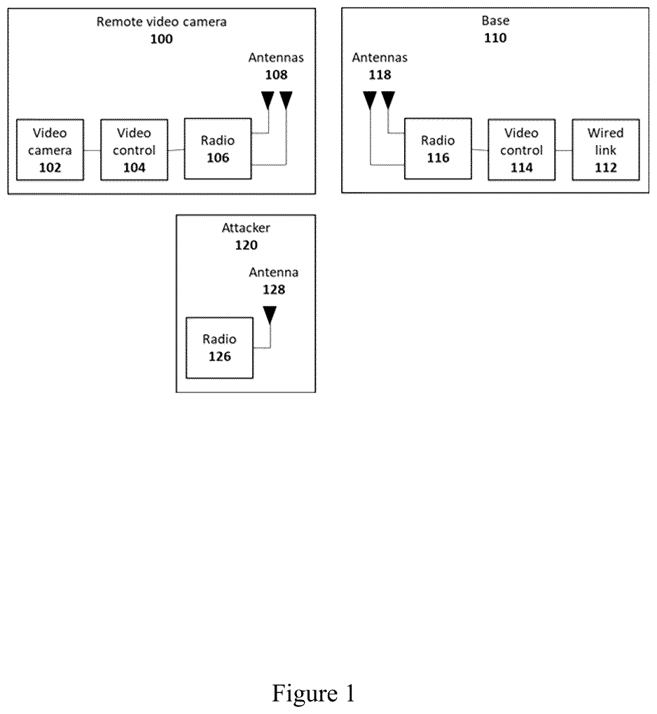

### DETAILED DESCRIPTION

Aspects of the subject matter described in this disclosure relate to robust wireless communication systems that utilize improved protocols (e.g., which may be modified and improved relative to cellular-based protocols, fourth generation (4G) systems, fifth generation (5G) systems, sixth generation (6G) systems, sidelink protocols, vehicle-to-everything (V2X) protocols). Such improved protocols may, for example, be optimized in one or more respects for point-to-point links with asymmetric data protocols. For example, a wireless communication system may implement a fixed slot sequence having more downlink slots than uplink slots within each frame, where uplink slots provide feedback information for downlink slots from previous frames while eliminating non-feedback control overhead to increase range, improve spectral efficiency, and improve interference resilience.

Particular aspects of the subject matter described in this disclosure can be implemented to realize one or more of the following potential advantages. In some examples, by implementing a fixed slot sequence having more downlink slots than uplink slots with cross-frame feedback and reduced control overhead, the described techniques may be used to increase range of communication links, improve spectral efficiency for asymmetric point-to-point communication links while maintaining reliable feedback mechanisms, and improving interference resilience compared to other (e.g., conventional) wireless protocols.

In accordance with one or more aspects described herein, a wireless communication system may implement a modified structure (e.g., relative to a previously developed 5G physical interface, relative to a previously developed cellular protocol structure, relative to sidelink) in order to improve wireless performance. For example, the wireless communication system may utilize a fixed slot sequence (e.g., a frame structure having a fixed slot sequence) having multiple first slots corresponding to a first communication direction (e.g., from a drone device to a base controller, a downlink direction) followed by at least one second slot (e.g., by a single second slot) corresponding to a second communication direction (e.g., from a based controller to a drone device, an uplink direction) that is opposite relative to the first communication direction (e.g., to optimize asymmetric data requirements). In some examples, such a second slot may provide feedback information for one or more first slots from one or more previous frames (e.g., including the current frame), while eliminating non-feedback link control information to reduce overhead, increase range, and improve spectral efficiency.

In some examples, the system may further implement adaptive bandwidth allocation for downlink transmissions while maintaining a fixed narrow bandwidth for uplink transmissions, and may dynamically adjust modulation schemes and transmit power based on channel and interference conditions. In some examples, by implementing the techniques described herein, wireless link performance may improve by 10 decibels (dB) or more, which may be the difference between receiving a video feed or failing to receive the feed, especially in buildings and drones. Accordingly, such a system, which enhances wireless receiver sensitivity, is presented herein.

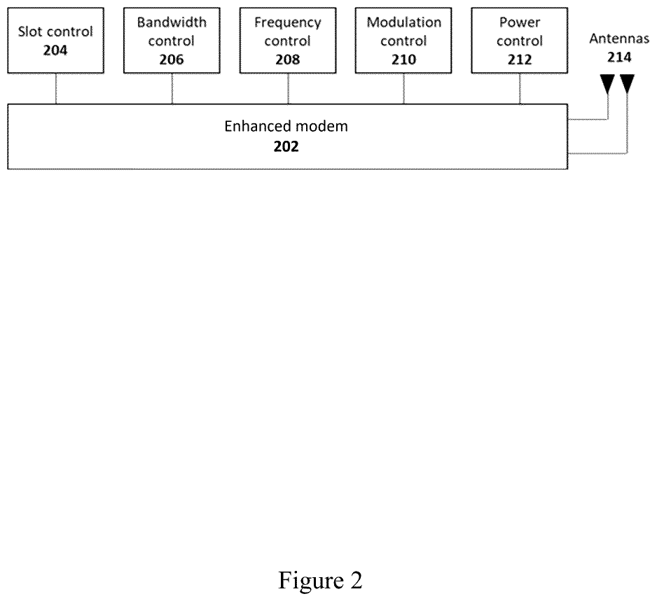

FIG. 2 illustrates a block diagram of a device (e.g., a more robust modem, and enhanced modem), which may, for example, be implemented in a remote video camera 100 (e.g., as part of the radio 106), in a base device 110 (e.g., as part of the radio 116), or some other device, with various parameters. A core component of the device may include an enhanced modem 202 (e.g., an enhanced 5G-vehicle-to-everything (V2X) modem). In some examples, the modem 202 may support one or more improved communication protocols and/or system structures. For example, the modem 202 may leverage various aspects of cellular-based system structures and may implement one or more features (e.g., optimizations) to improve point-to-point communications for some applications (e.g., remote cameras, drone-to-controller links). For instance, a baseline performance of a cellular-based wireless link may be superior to a Wi-Fi link and further optimizations, as described herein may be implemented for even better performance.

In some slot formats (e.g., a 5G new radio (NR) format), a slot within a frame (e.g., a 5 millisecond (ms) duration) may be designated as a downlink slot (e.g., a first communication direction, a 1 ms duration), an uplink slot (e.g., a second communication direction, which may be opposite the first communication direction, a 1 ms duration), or some other slot type. Such mechanisms may be leveraged from conventional cellular-based structure herein, and the interpretation of “downlink” and “uplink” may be extended for at least some applications. For instance, in some cases, “downlink” may refer to communication from a first device (e.g., a drone or other controlled device or vehicle, a user equipment (UE) streaming data to another UE, etc.) to a second device (e.g., a drone controller or vehicle controller, a UE receiving streamed data from the UE streaming the data, etc.) where the first device transmits a relatively higher data rate (e.g., video data, streaming content) compared to the second device. Additionally, “uplink” may refer to communication from the second device (e.g., the controller, UE receiving streamed data from the UE streaming the data, etc.) to the first device (e.g., the drone or other controlled device or vehicle, a UE streaming data to another UE, etc.) where the second device transmits a relatively lower data rate (e.g., control commands (e.g., commands for controlling the drone, controlled device/vehicle, UE streaming data), feedback information) compared to the first device.

In some examples, one or more aspects of communication protocols in a first direction (e.g., downlink) may be enhanced to achieve high spectral efficiency (e.g., thus supporting live video transmission). A downlink slot structure may be improved relative to previously developed cellular protocol slot formats (e.g., New Radio (NR) slot format, third generation partnership project (3GPP) NR-V2X sidelink air interface specifications) by removing one or more portions of control information (e.g., unnecessary control fields) to streamline operation and enhance performance. For example, a shared channel (e.g., NR-V2X) may carry multiple portions of link control information (e.g., sidelink control information (SCI)) during a downlink slot. For instance, a first portion of link control information (e.g., SCI-1) may carry basic resource usage information for initial communication setups, and a second portion of link control information (e.g., SCI-2) may carry more-detailed information and dynamic information for managing and coordinating resource reservations for future transmissions, such as resource reservation link control information (e.g., tailored for ongoing resource management in dense vehicular environments).

The size of this second portion of the link control information (e.g., SCI-2), may vary based on its format (e.g., ranging from 38 to 45 bits) and, depending on an allocation and a code rate applied, may occupy a significant portion of (e.g., up to 20 percent). However, this information may not be relevant to some applications (e.g., drone-to-controller links). Accordingly, at least some of the link control information (e.g., the SCI-2, resource reservation link control information) may be removed from each downlink slot, and its removal may free up additional resources for downlink payload. Additionally, or alternatively, the first portion of link control information (e.g., SCI-1) may be reduced (e.g., to 12 bits) by eliminating redundant one or more fields, thus minimizing overhead and enhancing the performance of the control channel. The remaining bits of the first portion may be allocated to minimal (e.g., essential) control information, including, for example, resource allocation information, modulation and coding scheme (MCS) information, redundancy version (RV) information (e.g., for hybrid automatic repeat request (HARQ)), slot number information, symbol quantity information (e.g., for long distance links), or any combination thereof.

As an illustrative example, a device (e.g., a drone) may transmit a first portion of link control information (e.g., SCI-1) corresponding to a frame, and may refrain from transmitting a second portion of link control information (e.g., SCI-2, the resource reservation related link control information) corresponding to the frame. In some examples, the device may refrain from transmitting the second portion based on the frame being configured in accordance with a fixed slot sequence.

In some examples, a device may adapt (e.g., dynamically) a bit rate of a downlink slot transmission based on one or more channel conditions, such as physical distance between devices (e.g., varying video camera distances), interferences levels, channel measurements (e.g., received signal strength indicator (RSSI)), or other conditions. For example, when channel conditions are optimal (e.g., close proximity between devices, low interference), the device may utilize a higher MCS configuration and/or maximum bandwidth allocation to achieve higher bit rates for transmitting high-definition video data. When channel conditions deteriorate (e.g., increased distance, elevated interference levels), the device may switch to a lower MCS configuration (e.g., having a modulation order of 4 or of 2) with reduced code rates and/or a narrower bandwidth allocation to maintain reliable communication links (e.g., to increase system sensitivity range) to ensure signal reception under challenging conditions.

Additionally, or alternatively, a device may adjust an allocated bandwidth (e.g., for a downlink slot) based on one or more channel conditions. For example, an allocated bandwidth may be adjusted between 2 megahertz (MHz) and 20 MHz. In some examples, such as low bit rate conditions, reducing bandwidth may improve a signal-to-noise-ratio (SNR) for improved signal processing and may enhance a control channel sensitivity. Under stable conditions (e.g., optimal conditions), a full bandwidth (e.g., 20 MHz) may maximize a bit rate when channel conditions allow.

For example, a downlink slot may employ multiple MCS options (e.g., up to 16 options) to optimize performance based on channel conditions. The system may continuously monitor one or more channel metrics, and through some higher layer (e.g., layer 2 (L2)) signaling, may request adjustments to increase or decrease the MCS accordingly. For instance (e.g., in a non-restricted prevention of significant deterioration (PSD) mode), the bandwidth may also be dynamically adjusted between 2.5 MHz and 20 MHz with 4 bandwidths. In some examples, given an error vector magnitude (EVM) estimation, a controller device may predict a highest bit rate (e.g., MCS) for the given EVM, and may signal a drone to change the MCS accordingly. Additionally, or alternatively, an MCS may be moved one step at a time based on a packet error rate (PER).

In some examples, one or more aspects of communication protocols in a second direction (e.g., uplink) may be enhanced to maximize downlink bit rates, to provide reliable feedback mechanisms, and improve resilience against interference. A function of an uplink slot may be to transmit acknowledgment (ACK) and negative acknowledgment (NACK) messages for one or more downlink slots, which may support maintaining maximum downlink bit rates and ensuring reliable communication links.

In some examples, an uplink slot may utilize a fixed narrow bandwidth (e.g., about 0.5 MHz, 0.54 MHz, three resource blocks (RBs)) to increase sensitivity and improve signal reception under challenging conditions. This fixed bandwidth allocation may contrast with dynamic bandwidth adaptation used in downlink slots, as the uplink's primary role may be to ensure reliable delivery of feedback information rather than maximizing data throughput. The narrow bandwidth may provide improved signal-to-noise ratio (SNR) characteristics, which may be particularly beneficial for maintaining communication links in interference-prone environments or at extended distances.

Additionally, or alternatively, an uplink slot may be configured with reduced control overhead by removing (e.g., eliminating) a substantial portion of link control information (e.g., all control information is removed from uplink slots, such as both SCI-1 and SCI-2) to minimize overhead and maximize available resources for payload transmission. That is, the uplink may utilize a fixed configuration, which reduces the utility of control information for reception and decoding. For example, parameters such as MCS information, bandwidth allocation, and other control parameters may be handled through higher protocol layers (e.g., L2 mechanisms) and may adjust gradually over time rather than being signaled within each slot.

In some examples, an uplink slot may provide feedback information (e.g., HARQ) for one or more downlink slots communicated previously (e.g., transmitted by a drone, received by a controller). For instance, in a frame structure having a frame duration (e.g., 5 milliseconds), an uplink slot may provide ACK/NACK feedback for downlink slots that were transmitted in a time range (e.g., 6 to 9 milliseconds) before the current uplink slot transmission. Additionally, or alternatively, a feedback latency may be fixed to a quantity of slots (e.g., F). In some examples, a controller may transmit feedback (e.g., associated with the received downlink slot(s)) in the form of a 1-bit ACK/NACK.

Various feedback modes may be supported. For instance, in a first mode, (e.g., when sensitivity or a noise floor is a limiting factor), a relatively low bit rate may be supported for an uplink slot. That is, each uplink transmission may provide feedback for a quantity (e.g., D) slots within a frame. In a second mode, a relatively high bit rate may be supported for the uplink slot. That is, each uplink transmission may provide feedback for twice the quantity of downlink slots (e.g., 2D where D slots are overlapping), which may provide double feedback on each downlink slot. In some examples, feedback re-transmission (e.g., RV2) may have a fixed distance from a first transmission (e.g., RV0).

The modem 202 may include, or be in communication with, various components to perform various aspects described herein. For example, the modem 202 may include, or be coupled with, a slot control module 204, a bandwidth control module 206, a frequency control module 208, a modulation control module 210, a power control module 212, and one or more antennas 214. In some examples, the modem 202 may use the one or more antennas 214 to communicate (e.g., transmit, receive, output, obtain, convey, monitor) data with one or more other devices via a wireless communication channel.

In some examples, the slot control module 204 may define a fixed slot sequence (e.g., a fixed time division multiplexing (TDM) sequence). The fixed sequence may include an ordered sequence of slots, which may be configured in accordance with a ratio of downlink slots-to-uplink slots (e.g., including any quantity of downlink slots and uplink slots where the quantity of downlink slots is greater than the quantity of uplink slots). Some example slot sequences may include four downlink slots followed by one uplink slot (e.g., a 4:1 ratio) or nine downlink slots followed by one uplink slot (e.g., a 9:1 ratio), among other examples.

The bandwidth control module 206 may adjust a downlink bandwidth size (e.g., based on SNR or other conditions) and may configure (e.g., fixes) an uplink bandwidth size (e.g., at 0.5 MHz). In some examples, the frequency control module 208 may manage a channel selection for transmission (e.g., may control frequency hopping). In cases of channel congestion (e.g., interference, suspected attacks), the frequency control module 208 may frequently change the downlink channel. In some examples, the frequency control module 208 may change the narrow uplink channel after each transmission.

In some examples, the modulation control module 210 may adjust a modulation scheme (e.g., an MCS, a bit rate) based on one or more channel conditionals (e.g., SNR) and/or feedback information obtained via upper layers. The power control module 212 may control transmission power.

As an illustrative example of the techniques described herein, communications between a first wireless communication device (e.g., a drone with video streaming capabilities) and a second wireless communication device (e.g., a base device that controls the drone, a drone controller) are described. The first device may transmit, via first slots (e.g., downlink slots) of a frame, first data to the second device. In some examples, the frame may include a fixed slot sequence having multiple first slots followed by a second slot (e.g., an uplink slot). In some examples, the first slots may have a first communication direction (e.g., downlink from the drone to the controller) and the second slot may have a second communication direction (e.g., uplink from the controller to the drone) opposite the first communication direction. In some examples, the fixed slot sequence may be configured (e.g., based on the slot control module 204) in accordance with a ratio of a first quantity of first slots to a second quantity of second slots, and the first quantity may be greater than the second quantity.

In some examples, the first device may transmit (e.g., via a downlink slot) a first portion of link control information (e.g., reduced information from SCI-1, a simplified SCI-1 message) for the second device and may refrain from transmitting a second portion of link control information (e.g., may remove, or not transmit, SCI-2) for the frame based on the frame being configured in accordance with the fixed slot sequence.

In some examples, the first device may (e.g., using the bandwidth control module 206) transmit the first data to the second device using an adjustable bandwidth, and may receive the second data may include receiving the second data using a fixed bandwidth. The first device may later transmit additional data using a different bandwidth based on one or more channel conditions.

In some examples, the first device may receive via the second slot of the frame, second data from the second device. The second data may include feedback information for at least one slot of the first slots, and non-feedback link control information may be absent from the second slot (e.g., the uplink slot may contain no control fields or control information). In some examples, the second data may include additional feedback information. For example, the second data may include second feedback information for at least a third slot (e.g., another downlink slot) of a second frame that occurs prior to the frame associated with the second slot (e.g., a previous frame).

Thus, by implementing the enhanced modem 202, some wireless communication systems may support improved reliability and improved spectral efficiency. For example, by implementing a fixed slot sequence with asymmetric downlink-to-uplink ratios combined with control overhead reduction, the described system may achieve improved spectral efficiency and enhanced wireless link performance. Removing the second portion of link control information (e.g., SCI-2) from downlink slots may free transmission resources for payload data, thereby increasing effective data throughput for video streaming applications. Additionally, utilizing a fixed narrow bandwidth for uplink transmissions while eliminating control information from uplink slots may achieve improved signal-to-noise ratio characteristics and enhanced sensitivity for reliable feedback delivery under interference conditions. These effects may result in improved wireless link performance, which may provide for reliable and robust wireless links in challenging environments.

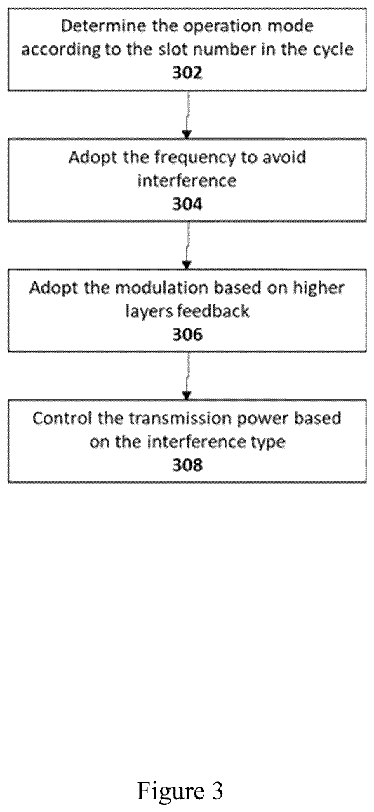

FIG. 3 shows an example of a flowchart that supports robust wireless link structures. In some examples, the operations of the flowchart may occur at a first wireless communication device (e.g., a drone, a remote video camera) and a second wireless communication device (e.g., a drone controller, a base device) during each slot (e.g., every 1 ms). At 302, the operation may begin where a mode of operation may determine based on a slot number in the cycle (e.g., as controlled by slot control module 204). For example, if a cycle contains 5 slots (e.g., the first 4 for downlink and the last for uplink), then the transmit or receive operation may be determined accordingly. At 304, the device may adopt (e.g., adjust, adapt) the frequency to avoid interference (e.g., as handled by the frequency control module 208). At 306, the device may adopt (e.g., adjust, adapt) the modulation based on feedback receive at one or more higher layers (e.g., as handled by modulation control module 210).

Accordingly, the flowchart described by FIG. 3 may provide enhanced adaptability and interference resilience. For example, by sequentially adapting frequency, modulation, and power parameters within each slot, the system may enable rapid response to changing channel conditions and interference scenarios. Additionally, power control adaptation based on interference type detection may distinguish between accidental interference and intentional attacks, and may enable countermeasures.

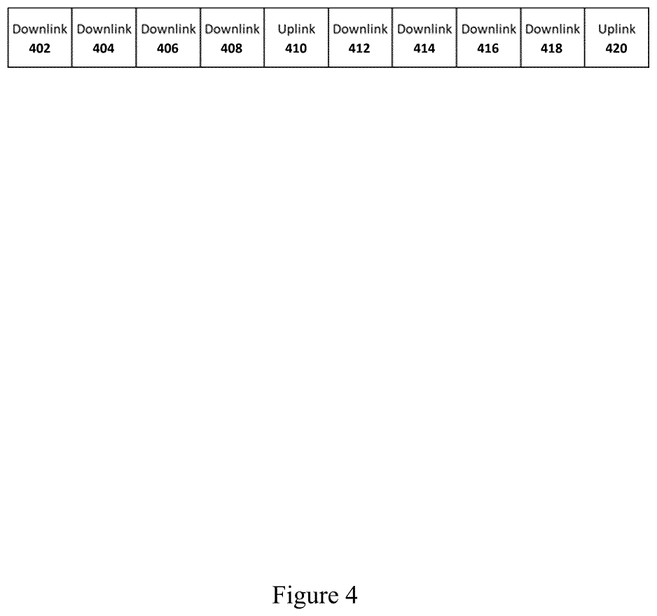

FIG. 4 shows an example of a slot structure (e.g., a fixed TDM slot structure) that supports robust wireless link structures. The slot structure represents a non-limiting example structure. That is, the techniques described herein may implement a slot structure that includes different patterns, ratios, or quantities of slots than shown (e.g., a 9:1 ratio). In the example of FIG. 4, the first four downlink slots, 402, 404, 406, and 408, followed by the uplink slot 410 may form one cycle. A subsequent set of downlink slots, 412, 414, 416, and 418, along with uplink slot 420 form the subsequent cycle. In some examples, the uplink slots may provide feedback about the reception status of any previous downlink slot. For example, the uplink slot 410 may provide feedback information for one or more of the downlink slots, 402, 404, 406, and 408. As another example, the uplink slot 420 may provide feedback information for one or more of the downlink messages 402, 404, 406, and 408 from the previous cycle, and/or for one or more downlink messages 412, 414, 416, and 418 from the subsequent cycle. Additionally, or alternatively, an uplink slots 410 and 420 may provide bandwidth, frequency, modulation, and power control through upper layer mechanisms, which may be embedded in the message content itself, instead of through a dedicated control channel.

Accordingly, the fixed slot structure described with reference to FIG. 4 may provide optimized resource allocation for asymmetric communication requirements. For example, by implementing a repeating downlink-to-uplink ratio, the system may efficiently support high-throughput video transmission while maintaining reliable feedback mechanisms. The cross-frame feedback capability may enable flexible retransmission strategies and continuous link quality monitoring.

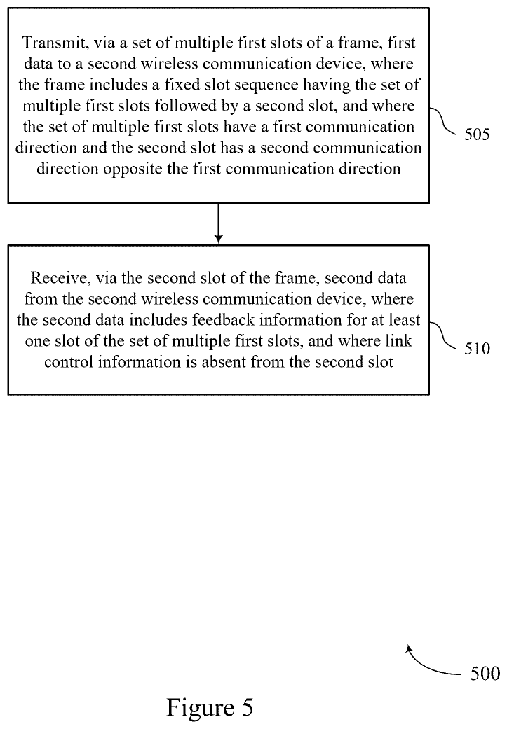

FIG. 5 shows a flowchart illustrating a method 500 that supports robust wireless link structures.

At 505, the method may include transmitting, via a set of multiple first slots of a frame, first data to a second wireless communication device, where the frame includes a fixed slot sequence having the set of multiple first slots followed by a second slot, and where the set of multiple first slots have a first communication direction and the second slot has a second communication direction opposite the first communication direction.

At 510, the method may include receiving, via the second slot of the frame, second data from the second wireless communication device, where the second data includes feedback information for at least one slot of the set of multiple first slots, and where link control information is absent from the second slot.

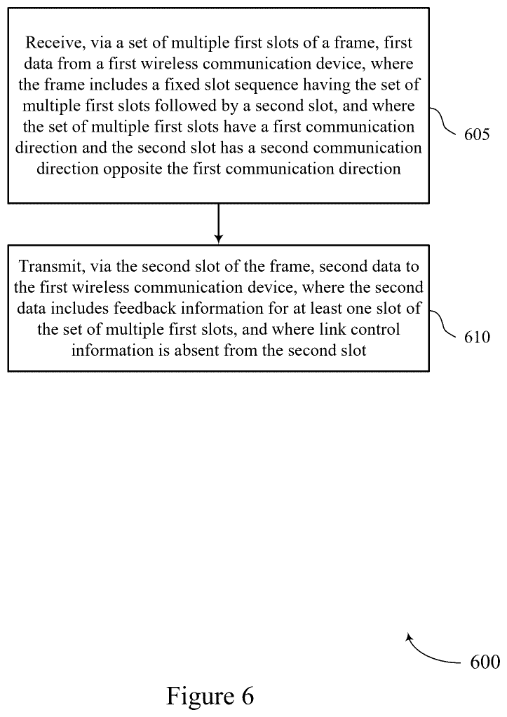

FIG. 6 shows a flowchart illustrating a method 600 that supports robust wireless link structures.

At 605, the method may include receiving, via a set of multiple first slots of a frame, first data from a first wireless communication device, where the frame includes a fixed slot sequence having the set of multiple first slots followed by a second slot, and where the set of multiple first slots have a first communication direction and the second slot has a second communication direction opposite the first communication direction.

At 610, the method may include transmitting, via the second slot of the frame, second data to the first wireless communication device, where the second data includes feedback information for at least one slot of the set of multiple first slots, and where link control information is absent from the second slot.

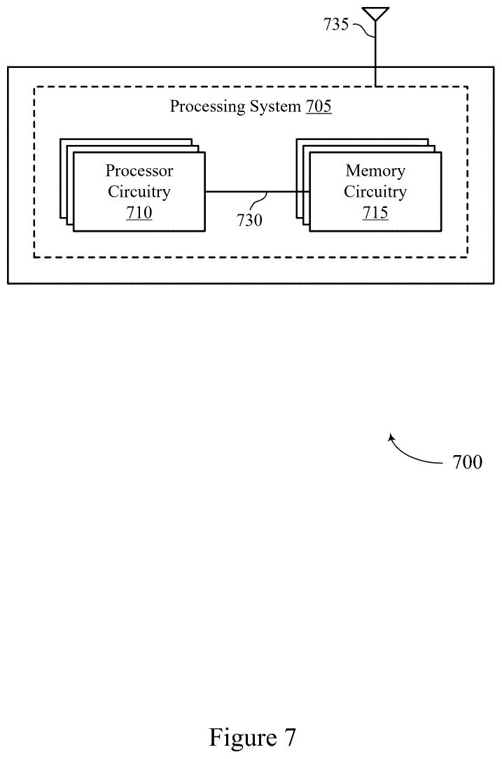

FIG. 7 shows a block diagram of an example wireless communication device 700 that supports sixth generation application drafting. A wireless communication device 700 may be capable of transmitting and receiving wireless communications in the form of, for example, wireless packets. For example, a wireless communication device 700 may be configurable or configured to transmit and receive signals and communications conforming to one or more 3GPP specifications including those for 5G NR or 6G, among others. Additionally, or alternatively, a wireless communication device 700 may be configurable or configured to transmit and receive signals and communications conforming to one or more of the IEEE 802.11 family of wireless communication protocol standards, among others.

In some examples, the wireless communication device 700 may be configured or configurable to perform one or more of the methods 500 or 600.

A wireless communication device 700 may include one or more chips, system on chips (SoCs), chipsets, packages, components, or devices that individually or collectively constitute or include a processing system 705. A processing system 705 may interface with other components of a wireless communication device 700 and may generally process information (such as inputs or signals) received from such other components and output information (such as outputs or signals) to such other components. As shown in FIG. 7, the wireless communication device 700 includes a processing system 705 that includes processor circuitry 710 (such as one or more processor circuits or circuitry, processing circuitry, a processor) and memory circuitry 715 (such as one or more memory circuits or circuitry, a memory).

Processor circuitry 710 may be collectively configured to perform PHY layer operations and MAC layer operations, and, in some instances, upper layer operations, associated with transmitting and receiving wireless communications. Processor circuitry 710 may be implemented in the form of one or multiple processors, microprocessors, application processors, host processors, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs) or digital signal processors (DSPs)), processing blocks, application-specific integrated circuits (ASIC), programmable logic devices (PLDs), or other discrete gate or transistor logic or circuitry (each of which may be generally referred to herein individually as “a processor” or “processor circuitry 710”). One or more processors of processor circuitry 710 may be individually or collectively configurable or configured to perform various functions or operations described herein. A group of processors of processor circuitry 710 collectively configurable or configured to perform a set of operations may include a first processor configurable or configured to perform a first operation of the set and a second processor configurable or configured to perform a second, different operation of the set. In some other examples, each of a group of processors of processor circuitry 710 may be configurable or configured to perform a same set of operations.

Memory circuitry 715 may be collectively configured for storing, accessing, or retrieving stored information at the request of processor circuitry 710, including operations associated with transmitting and receiving wireless communications.

Generally, components of memory circuitry 715 may be coupled with components of processor circuitry 710 and individually or collectively store processor-executable code that, when executed by the processor circuitry 710 (such as directly, indirectly, without pre-processing, after pre-processing), such as by one or more processors, may configure or enable the processor circuitry 710, such as one or more of the same or different processors, to perform various operations described herein. However, in some examples, some of the processor circuitry 710 may be preconfigured to perform various operations described herein without requiring configuration or enablement by code stored in the memory circuitry 715.

Memory circuitry 715 may be implemented in the form of one or more memory devices, memory components, memory blocks, memory elements or other discrete gate or transistor logic or circuitry. Memory circuitry 715 may include tangible storage media including non-volatile memory, such as read-only memory (ROM), or volatile memory, such as random-access memory (RAM) (such as static RAM (SRAM), dynamic RAM (DRAM), or synchronous DRAM (SDRAM) such as low power double data rate (LPDDR) memory, among other examples, each of which may be generally referred to herein individually as “a memory” or “memory circuitry 715”) In some examples, a processing system 705, and processor circuitry 710 within it, may also be coupled with memory circuitry outside of or distinct from the processing system 705. For example, such additional memory circuitry may include a non-volatile memory storage device such as a solid state drive (SSD), a hard disk drive (HDD), or removable storage media. In some other examples, additional memory circuitry also may include volatile memory such as SRAM, DRAM, SDRAM, LPDDR memory, among other examples.

Processor circuitry 710 may be coupled directly or indirectly with memory circuitry 715 via an interface 730 (such as one or more interfaces). An interface 730 may include any suitable quantities or types of interconnecting buses, bridges or circuitry depending on the specific applications and overall design constraints. In some examples, some or all of the processor circuitry 710 may be interconnected together within one chip, SoC, or package. Such a chip, SoC or package also may include memory circuitry 715 integrated within it. In some other examples, a processing system 705 may include any suitable combination of two or more distinct chips, SoCs, chipsets, packages, components, or devices, each of which may include respective processor circuitry 710 or memory circuitry 715, or both.

A wireless communication device 700 may also include any additional circuitry or components for processor circuitry 710 to operate to perform the functions and processes described herein related to wireless communication. For example, as is also shown in FIG. 7, a processing system 705 may be directly or indirectly coupled with one or more antennas 735, which may include antenna circuitry, one or more antenna components, one or more antenna modules, or one or more antenna panels, among other implementations. Additionally, in some examples, a processing system 705, including processor circuitry 710, may include, be coupled with, or be connected to one or more modem circuits or circuitry (not specifically shown), such as in the form of one or more modem chips (also referred to herein simply as “modems”), each including processor circuitry configured for performing modulation or demodulation of wireless communication signals, among other functions associated with PHY layer operations. In some examples, a wireless communication device 700 may alternatively include distinct modem circuitry, such as one or more modems, separate from but coupled with or connected to a processing system 705, such as including processor circuitry 710.

In some examples, modem circuitry, whether implemented internal to or external to a processing system 705, may also include, be coupled with, or be connected to one or more RF and analog circuits or circuitry (not specifically shown). In some examples in which a processing system 705 includes modem circuitry, the processing system 705 may include at least some of the RF and analog circuitry. In some other examples, most or all of the RF and analog circuitry may be separate from but coupled directly or indirectly with or connected to a processing system 705, such as to the modem circuitry. The RF and analog circuitry may include RF chains or transceiver circuitry (such as transceivers), which may include one or more filters, mixers, oscillators, amplifiers such as power amplifiers (PAs) or low-noise amplifiers (LNAs), analog-to-digital converters (ADCs), digital-to-analog converters (DACs), power trackers, or other components that process signals including converting them between analog (such as for transmission or reception via an air interface) and digital (such as for processing by the processor circuitry 710) domains. The RF and analogy circuitry may, in turn, be coupled with or connected to antenna modules that connect to the physical antennas or antenna arrays.

In some examples, a wireless communication device 700, may also include at least one other external network interface (not shown) that enables the processing system 705 to communicate with another network (such as a core network, a backhaul network) to gain access to external networks including the Internet. For example, a wireless communication device 700 may include multiple external network interfaces including one or more wired or wireless network interfaces (such as to support a backhaul link 132). A wireless communication device 700 may also include one or more external network interfaces, such as a WLAN interface, to provide a backhaul.

Implementation examples are described in the following numbered clauses:

Aspect 1: A method for wireless communications by a first wireless communication device, comprising: transmitting, via a plurality of first slots of a frame, first data to a second wireless communication device, wherein the frame comprises a fixed slot sequence having the plurality of first slots followed by a second slot, and wherein the plurality of first slots have a first communication direction and the second slot has a second communication direction opposite the first communication direction; and receiving, via the second slot of the frame, second data from the second wireless communication device, wherein the second data comprises feedback information for at least one slot of the plurality of first slots, and wherein link control information is absent from the second slot.

Aspect 2: The method of aspect 1, wherein the fixed slot sequence is configured in accordance with a ratio of a first quantity of first slots to a second quantity of second slots, and the first quantity is greater than the second quantity.

Aspect 3: The method of any of aspects 1 through 2, wherein transmitting the first data comprises: transmitting a first portion of link control information corresponding to the frame; and refraining from transmitting a second portion of link control information corresponding to the frame based at least in part on the frame being configured in accordance with the fixed slot sequence.

Aspect 4: The method of any of aspects 1 through 3, wherein the second data comprises second feedback information for at least a third slot of a second frame different than the frame.

Aspect 5: The method of any of aspects 1 through 4, wherein transmitting the first data comprises transmitting the first data using an adjustable bandwidth, and receiving the second data comprises receiving the second data using a fixed bandwidth.

Aspect 6: The method of any of aspects 1 through 5, wherein the first data is transmitted using a first bandwidth, the method further comprising: transmitting, via a plurality of third slots of a second frame after the frame, third data using a second bandwidth different than the first bandwidth based at least in part on one or more channel conditions.

Aspect 7: The method of any of aspects 1 through 6, wherein the first data is transmitted using a first modulation scheme, the method further comprising:

transmitting, via a plurality of third slots of a second frame after the frame, third data using a second modulation scheme different than the first modulation scheme based at least in part on one or more channel conditions.

Aspect 8: The method of any of aspects 1 through 7, wherein the first wireless communication device comprises a drone and the second wireless communication device comprises a base device that controls the drone.

Aspect 9: A method for wireless communications by a second wireless communication device, comprising: receiving, via a plurality of first slots of a frame, first data from a first wireless communication device, wherein the frame comprises a fixed slot sequence having the plurality of first slots followed by a second slot, and wherein the plurality of first slots have a first communication direction and the second slot has a second communication direction opposite the first communication direction; and transmitting, via the second slot of the frame, second data to the first wireless communication device, wherein the second data comprises feedback information for at least one slot of the plurality of first slots, and wherein link control information is absent from the second slot.

Aspect 10: The method of aspect 9, wherein the fixed slot sequence is configured in accordance with a ratio of a first quantity of first slots to a second quantity of second slots, and the first quantity is greater than the second quantity.

Aspect 11: The method of any of aspects 9 through 10, wherein receiving the first data comprises: receiving a first portion of link control information corresponding to the frame.

Aspect 12: The method of any of aspects 9 through 11, wherein the second data comprises second feedback information for at least a third slot of a second frame different than the frame.

Aspect 13: The method of any of aspects 9 through 12, wherein receiving the first data comprises receiving the first data using an adjustable bandwidth, and transmitting the second data comprises transmitting the second data using a fixed bandwidth.

Aspect 14: The method of any of aspects 9 through 13, wherein the first data is received using a first bandwidth, the method further comprising: receiving, via a plurality of third slots of a second frame after the frame, third data using a second bandwidth different than the first bandwidth based at least in part on one or more channel conditions.

Aspect 15: The method of any of aspects 9 through 14, wherein the first data is received using a first modulation scheme, the method further comprising: receiving, via a plurality of third slots of a second frame after the frame, third data using a second modulation scheme different than the first modulation scheme based at least in part on one or more channel conditions.

Aspect 16: The method of any of aspects 9 through 15, wherein the second wireless communication device comprises a base device that controls the first wireless communication device, and the first wireless communication device comprises a drone.

Aspect 17: A first wireless communication device for wireless communications, comprising a processing system that includes processor circuitry and memory circuitry that stores code, the processing system configured to cause the first wireless communication device to perform a method of any of aspects 1 through 8.

Aspect 18: A first wireless communication device for wireless communications, comprising at least one means for performing a method of any of aspects 1 through 8.

Aspect 19: A non-transitory computer-readable medium storing code for wireless communications, the code comprising instructions executable by one or more processors to perform a method of any of aspects 1 through 8.

Aspect 20: A second wireless communication device for wireless communications, comprising a processing system that includes processor circuitry and memory circuitry that stores code, the processing system configured to cause the second wireless communication device to perform a method of any of aspects 9 through 16.

Aspect 21: A second wireless communication device for wireless communications, comprising at least one means for performing a method of any of aspects 9 through 16.

Aspect 22: A non-transitory computer-readable medium storing code for wireless communications, the code comprising instructions executable by one or more processors to perform a method of any of aspects 9 through 16.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,” “comprise,” “comprising,” “include” and “including,” and derivatives thereof or similar terms are intended to be open-ended terms that do not limit an element that they modify (for example, an element “having” a also may have b).

As used herein, the phrase “based on” is equivalent to “based at least in part on” and indicates a non-limiting relationship between elements “a” and “b.” In some aspects, a′ (which may be a variation or example of a) may be responsive to or in response to b′ (which may be a variation or example of b), such as if condition c is met. In some other aspects, a″ (which may be a variation or example of at least one of a or a′) may be associated with b″ (which may be a variation or example of at least one of b or b′). In some further aspects, a′″ (which may be a variation or example of at least one of a or a′ or a″) may be determined (or any of the other actions encompassed by usage of the word “determining” as described above) in accordance with b′″ (which may be a variation or example of at least one of b or b′ or b′). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
one or more memories;
a transceiver; and
one or more processors coupled with the one or more memories, the one or more processors individually or collectively configured to:
transmit, via the transceiver and using a plurality of first slots of a frame, first data to a second wireless communication device, wherein the frame comprises a fixed slot sequence having the plurality of first slots followed by a second slot, and wherein the plurality of first slots have a first communication direction and the second slot has a second communication direction opposite the first communication direction; and
receive, via the transceiver and using the second slot of the frame, second data from the second wireless communication device, wherein the second data comprises feedback information for at least one slot of the plurality of first slots, and wherein non-feedback link control information is absent from the second slot.

2. The first wireless communication device of claim 1, wherein:
the fixed slot sequence is configured in accordance with a ratio of a first quantity of first slots to a second quantity of second slots, and
the first quantity is greater than the second quantity.

3. The first wireless communication device of claim 1, wherein, to transmit the first data, the one or more processors are individually or collectively configured to:
transmit, via the transceiver, a first portion of link control information corresponding to the frame; and
refrain from transmitting resource reservation related link control information corresponding to the frame based at least in part on the frame being configured in accordance with the fixed slot sequence.

4. The first wireless communication device of claim 1, wherein the second data comprises second feedback information for at least a third slot of a second frame different than the frame.

5. The first wireless communication device of claim 1, wherein the one or more processors are individually or collectively configured to:
transmit the first data using an adjustable bandwidth, and
receive the second data using a fixed bandwidth.

6. The first wireless communication device of claim 1, wherein the one or more processors are individually or collectively configured to transmit the first data using a first bandwidth, and are further configured to:
transmit, via the transceiver and using a plurality of third slots of a second frame after the frame, third data using a second bandwidth different than the first bandwidth based at least in part on one or more channel conditions.

7. The first wireless communication device of claim 1, wherein the one or more processors are individually or collectively configured to transmit the first data using a first modulation scheme, and are further configured to:
transmit, via the transceiver and using a plurality of third slots of a second frame after the frame, third data using a second modulation scheme different than the first modulation scheme based at least in part on one or more channel conditions.

8. The first wireless communication device of claim 1, wherein the first wireless communication device comprises a drone and the second wireless communication device comprises a base device that controls the drone.

9. A second wireless communication device, comprising:
one or more memories storing processor-executable code;
a transceiver; and
one or more processors coupled with the one or more memories and individually or collectively configured to:
receive, via the transceiver and using a plurality of first slots of a frame, first data from a first wireless communication device, wherein the frame comprises a fixed slot sequence having the plurality of first slots followed by a second slot, and wherein the plurality of first slots have a first communication direction and the second slot has a second communication direction opposite the first communication direction; and
transmit, via the transceiver and using the second slot of the frame, second data to the first wireless communication device, wherein the second data comprises feedback information for at least one slot of the plurality of first slots, and wherein link control information is absent from the second slot.

10. The second wireless communication device of claim 9, wherein:
the fixed slot sequence is configured in accordance with a ratio of a first quantity of first slots to a second quantity of second slots, and
the first quantity is greater than the second quantity.

11. The second wireless communication device of claim 9, wherein, to receive the first data, the one or more processors are individually or collectively configured to:
receive, via the transceiver, a first portion of link control information corresponding to the frame.

12. The second wireless communication device of claim 9, wherein the second data comprises second feedback information for at least a third slot of a second frame different than the frame.

13. The second wireless communication device of claim 9, wherein the one or more processors are individually or collectively configured to:
receive the first data using an adjustable bandwidth, and
transmit the second data using a fixed bandwidth.

14. The second wireless communication device of claim 9, wherein the one or more processors are individually or collectively configured to receive the first data using a first bandwidth, and are further configured to:
receive, via the transceiver and using a plurality of third slots of a second frame after the frame, third data using a second bandwidth different than the first bandwidth based at least in part on one or more channel conditions.

15. The second wireless communication device of claim 9, wherein the one or more processors are individually or collectively configured to receive the first data using a first modulation scheme, and are further configured to:
receive, via the transceiver and using a plurality of third slots of a second frame after the frame, third data using a second modulation scheme different than the first modulation scheme based at least in part on one or more channel conditions.

16. The second wireless communication device of claim 9, wherein:
the second wireless communication device comprises a base device that controls the first wireless communication device, and
the first wireless communication device comprises a drone.

17. A method for wireless communications by a first wireless communication device, comprising:
transmitting, via a plurality of first slots of a frame, first data to a second wireless communication device, wherein the frame comprises a fixed slot sequence having the plurality of first slots followed by a second slot, and wherein the plurality of first slots have a first communication direction and the second slot has a second communication direction opposite the first communication direction; and
receiving, via the second slot of the frame, second data from the second wireless communication device, wherein the second data comprises feedback information for at least one slot of the plurality of first slots, and wherein link control information is absent from the second slot.

18. The method of claim 17, wherein:
the fixed slot sequence is configured in accordance with a ratio of a first quantity of first slots to a second quantity of second slots, and
the first quantity is greater than the second quantity.

19. The method of claim 17, wherein the second data comprises second feedback information for at least a third slot of a second frame different than the frame.

20. The method of claim 17, further comprising:
transmitting the first data using an adjustable bandwidth, and receiving the second data using a fixed bandwidth.
